(19) United States
(12) Patent Application Publication
(10) Pub. No.: US 2010/0186679 A1
(43) Pub. Date: Jul. 29, 2010

(54) PET GROOMING TOOL

(76) Inventor: Lawrence A. Woods, San Jose, CA (US)

Correspondence Address: GREGORY SMITH & ASSOCIATES, 3900 NEWPARK MALL ROAD, 3RD FLOOR, NEWARK, CA, 94560, US

(21) Appl. No.: 12/754,505

(22) Filed: Apr. 5, 2010

Related U.S. Application Data
(63) Continuation-in-part of application No. 12/652,682, filed on Jan. 5, 2010.
Application No. 12/652,682 is a continuation of application No. 11/521,764, filed on Sep. 15, 2006, now Pat. No. 7,640,893.

(51) Int. Cl. A01K 13/00

(52) U.S. Cl. 119/601; 119/627; 119/609; 119/603; 119/611

(57) ABSTRACT

A grooming tool includes at least three latex surgical tubing pieces generally arranged in parallel to one another, and anchored together at corresponding opposite ends. A handle provides for a user to draw the latex surgical tubing pieces across an animal for grooming. Some embodiments of a grooming tool include a hollow shaft, a pressure cap, and a plurality of fluid dispensing comb teeth for dispensing fluid stored inside the grooming tool onto the skin or fur of an animal being groomed. Some embodiments of a grooming tool include one or more detachable grooming accessories such as a comb, brush, heating pad accessory, fluid dispensing comb, or vibrator accessory. Some detachable grooming accessories may be attached to a grooming tool in combination with another detachable grooming accessory.

### CROSS REFERENCE TO OTHER APPLICATIONS

This application is a continuation in part of U.S. patent application Ser. No. 12/652,682, filed on Jan. 5, 2010, which is a continuation of U.S. patent application Ser. No. 11/521,764, filed on Sep. 15, 2009, now U.S. Pat. No. 7,645,296, the specification of which is incorporated herein by reference in its entirety.

### FIELD OF THE PRESENT INVENTION

The present invention relates to grooming tools for animals, and in particular to brushes and combs for removing loose animal hair or fur.

### BACKGROUND

Keeping an animal healthy and clean includes grooming their fur to remove loose hairs and debris. Various combs and brushes have been marketed that do well in one situation or the other. Richard Gordon describes a grooming comb for pets in U.S. Pat. No. 4,799,457, issued Jan. 24, 1989. It comprises a combined shredding and grooming tool made from a strip of plastic with two different types of comb teeth on its edges, and handles on opposite ends.

Frederick Eckert describes a grooming element in U.S. Pat. No. 1,285,957, issued Nov. 26, 1918. A brush with a handle is provided that is said to be especially good at removing mud and dirt from the legs of draft animals. Several parallel even loops of wire are each anchored at both ends and bow out from a backing board. The wire loops are drug crosswise across the dirt to be brushed off.

Hugo Ewart describes a currycomb in U.S. Pat. No. 753,056, issued Feb. 23, 1904, that is essentially made entirely from wire. A brush arrangement is made by twisting rows of wire to form loops that act like teeth or bristles. Several rows of these are set in parallel and a wire-formed handle is attached.

Another currycomb or card cleaner is described by Charles Flanders in U.S. Pat. No. 717,377, issued Dec. 30, 1902. Here, a snap-on grille is placed over the bristles of a brush. When the bristles load up with hair, the hair is easily removed by removing the grille.

A linked chain-mail wire material is wrapped around the drum of a brush and handle to form a round currycomb brush in U.S. Pat. No. 681,707, issued Sep. 3, 1901, to James Johnson. The rounded teeth-like projections of the interlinked parallel coils of wire do not get clogged and are easily cleaned.

William Cole describes a horse cleaner brush in U.S. Pat. No. 463,942, issued Nov. 24, 1891. A round handle supports a cylindrical frame over which several parallel straight wires are longitudinally strung. The strings resemble those of a violin, but wrap around the entire circumference over a grooved head at the end opposite to the handle. The string tension is made adjustable to make the wires taut.

Orlando Jenness describes a curry comb in a flat brush arrangement with a handle in U.S. Pat. No. 360,301, issued Mar. 29, 1887. Several strands of twisted ribbons of metal are arranged in parallel above a box-like frame and backer board. These “bars” are traversely dragged across an animal's fur to clean and groom it. The resulting comb is said to control dust and provide a very long service life.

What is needed is a brush that grooms animals quickly and efficiently, and that is easy to clean and use again.

### SUMMARY OF THE PRESENT INVENTION

The invention includes an animal grooming tool, made in accord with the invention, in which a plurality of latex surgical tubing pieces generally arranged in parallel to one another, and anchored as a group at corresponding opposite ends, and a handle providing for a user to draw the plurality of latex surgical tubing pieces across an animal for grooming.

One embodiment of the present invention comprises a pet grooming tool having a number of pieces of natural rubber latex surgical tubing strung in parallel between rotatable matching disks or arms. The tubing arrangements can be parallel in a plane, or in a cylinder. The rotating parts are mounted to a handle to allow the brushing action on an animal to cause the rotation. The surgical tubing stretches and grips during use and clings to loose hairs and debris. An auxiliary comb with graduated teeth spacing is provided to assist with grooming.

An advantage of the present invention is a grooming tool is provided that is effective and easy to use.

Another advantage of the present invention is a grooming tool is provided that can be used for massage and improving blood circulation in the skin.

A further advantage of the present invention is a grooming tool is provided that is easy to clean of hair.

Yet another advantage of the present invention is a grooming tool is provided that can be used to dispense and spread liquids, gels, or pastes onto an animal's fur during combing of the fur with the grooming tool.

The above summary of the present invention is not intended to represent each disclosed embodiment, or every aspect, of the present invention. Other aspects and example embodiments are provided in the figures and the detailed description that follow.

### BRIEF DESCRIPTION OF THE DRAWINGS

The present invention may be more completely understood in consideration of the following detailed description of various embodiments of the present invention in connection with the accompanying drawings, in which:

FIG. 1 is a perspective view diagram of grooming tool embodiment of the present invention showing a rotating cylindrical arrangement of surgical tubing and a comb on a brush handle;

FIG. 2 is a perspective view diagram of another grooming tool embodiment of the present invention showing a rotating cylindrical arrangement of surgical tubing only on a brush handle;

FIG. 3 is a plan view diagram of an end disk with four tubing nipples arranged in a circle that could be used in the brushes illustrated in FIGS. 1 and 2;

FIG. 4 is a perspective view diagram of a third grooming tool embodiment of the present invention showing a rotating flat panel arrangement of surgical tubing on a brush handle;

FIG. 5 is a plan view diagram of an arm with four tubing nipples arranged in a flat panel that could be used in the brush illustrated in FIG. 4;

FIG. 6 is a perspective view diagram of a brush embodiment of the present invention in which several equal lengths of surgical tubing are arranged in parallel and allowed to each turn on its own axis to promote adhesion to an animal's hair and removal during grooming;

FIG. 7 is a top view diagram of a hollow shaft for another embodiment of a grooming tool;

FIG. 8 is a cross section diagram of the hollow shaft of FIG. 7, for which the location and viewing direction for the cross section are shown by a line marked A-A in FIG. 7;

FIG. 9 is a side view diagram of an embodiment of a grooming tool which includes the hollow shaft of FIG. 7 and FIG. 8;

FIG. 10 is a side view diagram of an example of a detachable comb which may optionally be used with a grooming tool in accord with an embodiment of the invention, for example the grooming tool of FIG. 9;

FIG. 11 is an end view diagram of the example of a detachable comb of FIG. 10;

FIG. 12 is a side view diagram of an example of a detachable brush which may optionally be used with a grooming tool in accord with an embodiment of the invention, for example the grooming tool of FIG. 9;

FIG. 13 is an end view diagram of the example of a detachable brush of FIG. 12;

FIG. 14 is a pictorial view diagram of an example of a detachable comb having more than one row of comb teeth;

FIG. 15 is a pictorial view diagram of an example of a detachable heating pad accessory;

FIG. 16 is a perspective view diagram of the grooming tool example of FIG. 9, illustrating the detachable comb of FIG. 10 and FIG. 11 on the hollow shaft of FIG. 7;

FIG. 17 is a side view diagram of the embodiment of a grooming tool of FIG. 9, illustrating additional components which may optionally be attached to the grooming tool to enable fluid, paste, or gel to be stored inside the tool and dispensed from the tool;

FIG. 18 is a side view diagram of an example of a fluid dispensing comb tooth;

FIG. 19 is an end view diagram of the example of a fluid dispensing comb tooth of FIG. 18;

FIG. 20 is a cross section diagram of the fluid dispensing comb tooth example of FIG. 18 and FIG. 19, in which a location and viewing direction for the cross section are shown by a line marked B-B in FIG. 19;

FIG. 21 is an alternative cross section diagram of the fluid dispensing comb tooth in which the slidable tip portion of the fluid dispensing comb tooth is shown in a depressed position for dispensing a fluid stored in the hollow shaft of the grooming tool of FIG. 17;

FIG. 22 is a perspective view diagram of an example of a pressure cap for use with an embodiment of the invention having a fluid dispensing comb;

FIG. 23 is a perspective view diagram of the grooming tool example of FIG. 17.

FIG. 24 is a side view diagram an example of a detachable fluid dispensing comb;

FIG. 25 is a side view diagram of the detachable fluid dispensing comb of FIG. 24 attached to the grooming tool of FIG. 9;

FIG. 26 is a is a schematic diagram of an electrical circuit for a detachable grooming accessory including a vibrator;

FIG. 27 is a side view diagram of a detachable grooming accessory comprising a vibrator;

FIG. 28 is a side view diagram of an example of a combination of detachable grooming accessories comprising a detachable comb attached to vibrator;

FIG. 29 is a side view diagram of another example of a combination of detachable grooming accessories comprising a detachable brush attached to vibrator; and

FIG. 30 is a side view diagram of a yet another example of a combination of detachable grooming accessories comprising a detachable heating pad accessory attached to vibrator.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention as defined by the appended claims.

### DETAILED DESCRIPTION

In general, the invention includes an animal grooming tool with a plurality of latex surgical tubing pieces generally arranged in parallel to one another, and anchored as a group at corresponding opposite ends. Preferred embodiments also include a handle providing for a user to draw the plurality of latex surgical tubing pieces across an animal for grooming.

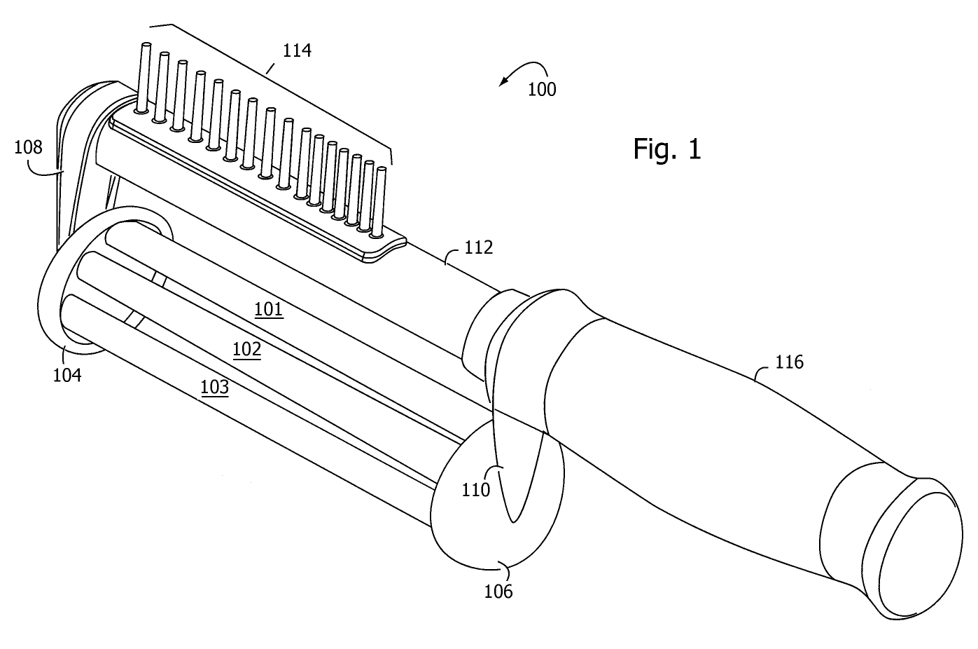

FIG. 1 shows a grooming tool embodiment of the present invention, and is referred to herein by the general reference numeral 100. The grooming tool 100 may be used as a brush and comb to groom animals. It comprises several pieces of latex surgical tubing 101-103 strung between rotatable disks 104 and 106. These turn like a drum on two arms 108 and 110 attached to a shaft 112. A comb 114 is mounted on the back of shaft 112 and spaces some of its teeth farther apart on one end than the other. The user can then choose which part of the tool is best to use when encountering different types of hair, fur, and dirt. A handle 116 is provided for comfortable use.

The use of latex surgical tubing 101-103 is critical to the present invention. The material properties of natural rubber latex provide a combination of adhesion and flexibility that is very efficient in grooming when allowed to rotate in an assembly as shown in FIG. 1. Silicone tubing may be a useful alternative, but such may not cling to hair so well. Here, in FIG. 1, three pieces of latex tubing 101-103 are visible, but four or more pieces can also be used. A prototype that worked well used four pieces of ⅜″ ID latex tubing arranged in a circle about 1.5″ in diameter. That provided about ¾″ between adjacent pieces. During use, the pieces 101-103 while rotating and being pressed against the animal can be drawn closer together. There may be an advantage to make the tubing a bit longer than is necessary to bridge the distance between disks 104 and 106. Such prototype spaced the disks 104 and 106 about 5-6″ apart. The materials used for the rest of the construction are conventional, e.g., ordinary plastics, metals, or wood.

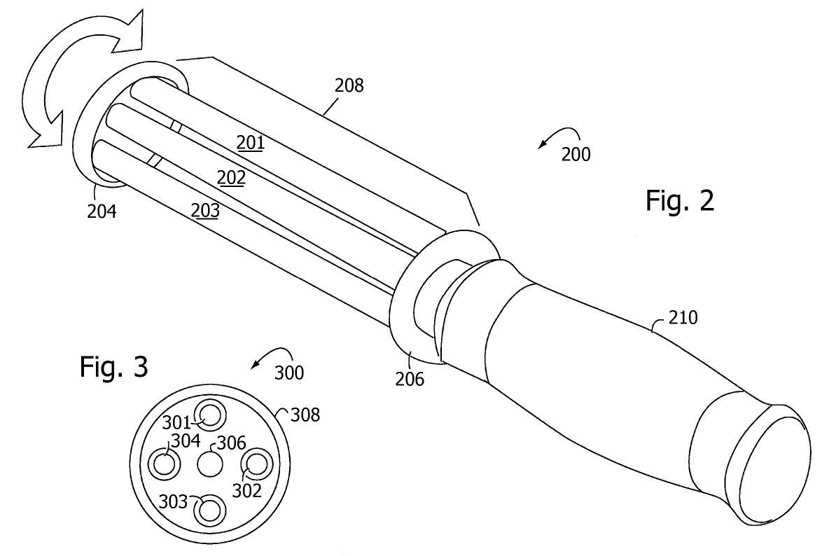

FIG. 2 represents a brush embodiment of the present invention, and is referred to herein by the general reference numeral 200. The brush 200 is similar to that of FIG. 1, but has no comb and a simpler handle. Brush 200 also has several pieces of latex surgical tubing 201-203 strung between rotatable disks 204 and 206. These turn together as a drum assembly 208 spindled to a handle 210.

FIG. 3 shows a detailed view of a disk 300 similar to disks 204 and 206 of FIGS. 2 and 104 and 106 of FIG. 1. Each piece of surgical tubing is connected to a nipple 301-304, e.g., ⅜″ in diameter and in length. A center hole 306 provides for an axle, e.g., a simple shaft with machine screws and nuts snugged tight enough to allow rotation without wobbling. These are all disposed on an end plate 308. In an alternative embodiment, assembly 208 does not rotate on handle 210, the user simply allows the whole brush to roll over the animal's fur during grooming.

FIG. 4 represents another brush embodiment of the present invention, and is referred to herein by the general reference numeral 400. The brush 400 is similar to that of FIG. 2, but has a flat arrangement. Brush 400 also has four pieces of latex surgical tubing 401-404 strung between rotatable stretchers 406 and 408. These turn together as a drum assembly 410 spindled in tandem to handles 412-413. Two hands can be used with the two handles 412-413 to apply more pressure than could be comfortably applied with one hand using only a single handle 412.

Such spindle may be best if the latex surgical tubing 401-404 strung between rotatable stretchers 406 and 408 are allowed to be a bit floppy or loose. It may also be advantageous for the spindle arrangement to the rotatable stretchers 406 and 408 to be locked together.

Four pieces of latex surgical tubing 401-404 are shown here in FIG. 4 being strung between rotatable stretchers 406 and 408, but the best number of tubings, tubing size and tubing lengths will depend on the particular application. In an alternative embodiment, assembly 410 does not rotate on handle 412, or handles 412-413, the user simply allows the whole brush 400 to occasionally fold or flop over the animal's fur during grooming.

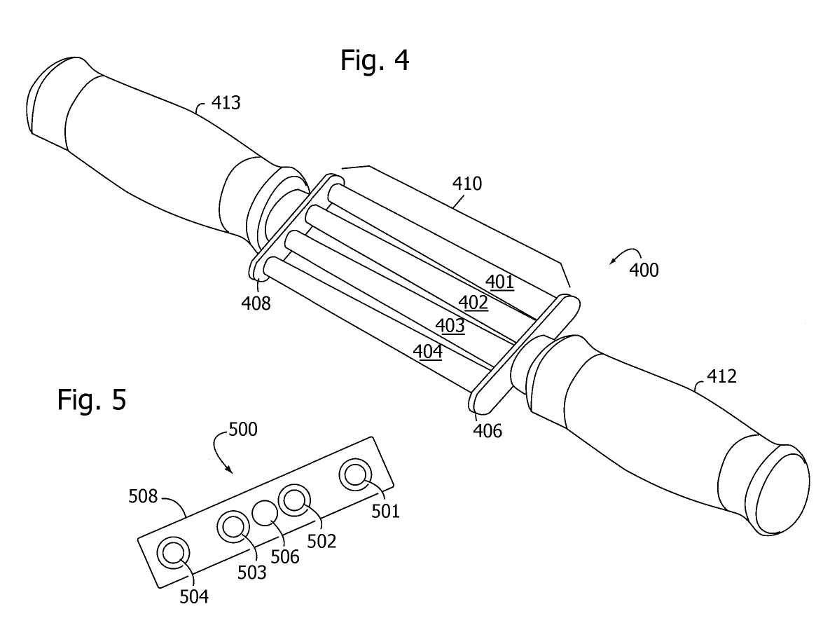

FIG. 5 shows a detailed view of a rotatable stretcher 500 similar to rotatable stretchers 406 and 408 of FIG. 4. Each piece of surgical tubing is connected to a nipple 501-504, e.g., ⅜″ in diameter and in length. A typical length would be about six inches. A center hole 506 provides for an axle, e.g., a simple shaft with machine screws and nuts snugged tight enough to allow rotation. These are all disposed on an end plate 508.

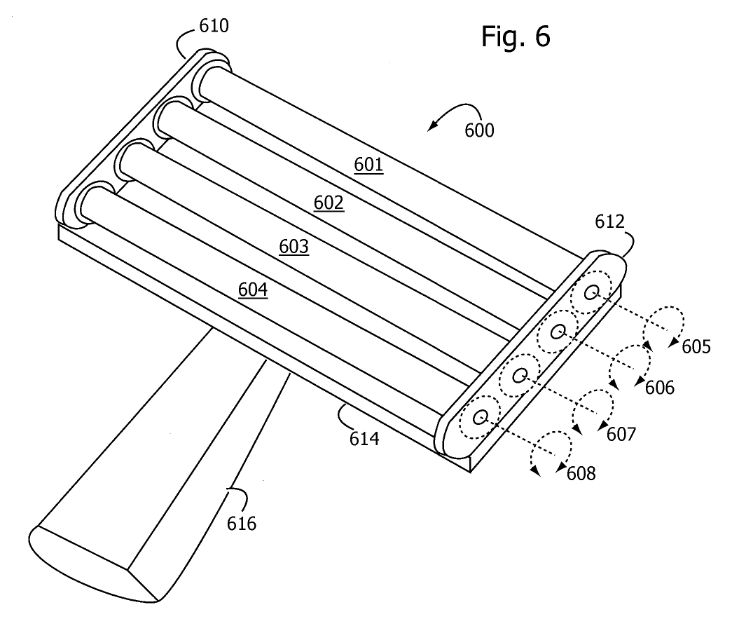

FIG. 6 illustrates a flat brush embodiment of the present invention, and is referred to herein by the general reference numeral 600. Brush 600 uses the arrangement of several surgical tube pieces 601-604 all of equal length. There may be some advantage in particular applications to not keeping the surgical tube pieces 601-604 all of equal length. Here, each can spin on a corresponding axis 605-608, either as a gang or individually, depending on application. End plates 610 and 612 provide axle support and attack to a backing plate 614. A handle 616 allows the user to draw the brush across an animal's fur for grooming.

Many arrangements of surgical tubing are possible that would be useful in grooming. For example, a frame comparable in shape to an empty tennis racket may be strung with a coil of surgical tubing with parallel windings between the frame perimeters. Such an arrangement may offer advantages such as being easy and inexpensive to manufacture.

Silicone tubing has a better deterioration rate but it is surpassed by latex surgical tubing in elasticity, flexibility and gripping power. Latex surgical tubing is flexible in sub-zero temperatures, maintains memory after repeated stretching, and has tremendous holding strength and adhesiveness. Latex surgical tubing comes in black or amber; there is no difference in the properties of colors for the embodiments of the invention disclosed herein. Latex products are manufactured from a milky fluid derived from the rubber tree, Hevea brasiliensis. Several chemicals are added to this fluid during the processing and manufacture of commercial latex. Some individuals are allergic to latex contact, and an alternative rubber-like material may be better in some uses.

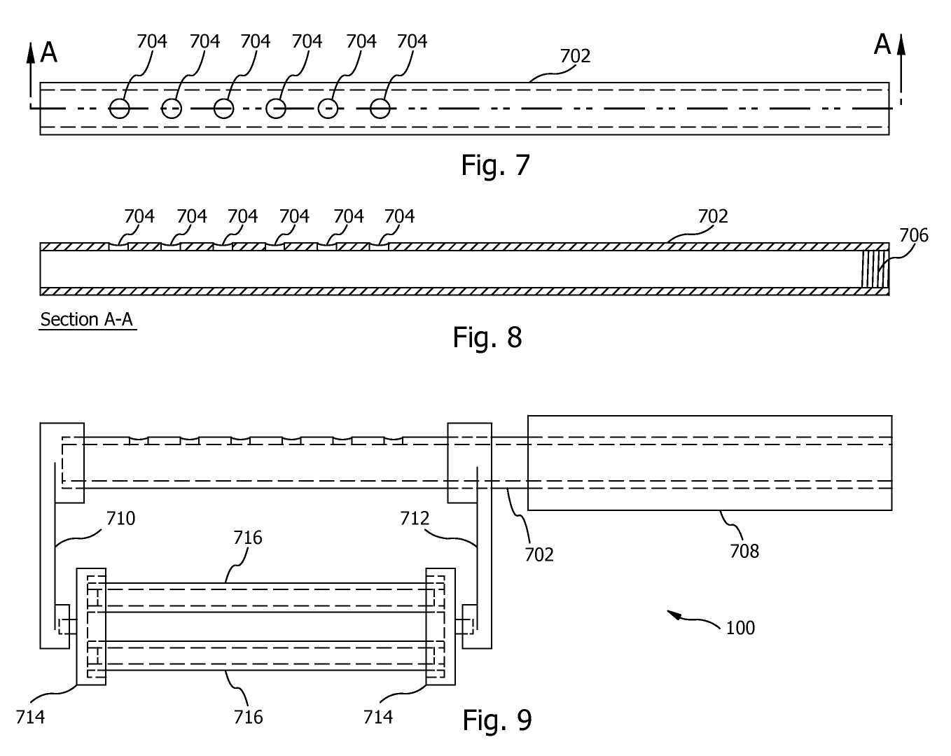

In the grooming tool example of FIG. 1, the comb 114 is attached to a shaft 112. In some embodiments of a grooming tool, the shaft is hollow. A hollow shaft may optionally be used to store a fluid such as a liquid, gel, paste, or fine powder for application to the fur of an animal during grooming. An example of a hollow shaft is shown in FIG. 7 and FIG. 8. FIG. 7 shows a top view of a hollow shaft 702 having a plurality of internally threaded holes 704. FIG. 8 shows a cross section of the hollow shaft of FIG. 7. A location and viewing direction for the cross section of FIG. 8 are shown by a line marked A-A in FIG. 7. FIG. 8 further illustrates six internally threaded holes 704 and internal threading 706 at one end of the hollow shaft 702. Other embodiments of a threaded shaft 702 may optionally have a different number, size, and location of internally threaded holes 704 than are shown in the example of FIG. 7 and FIG. 8.

The hollow shaft from FIG. 7 and FIG. 8 is shown in an example of a grooming tool 100 in FIG. 9. In the example of FIG. 9, an end arm 710 is placed over an open end of the hollow shaft 702. The end arm 710 is provided with a blind hole having a size and shape selected for a close sliding fit of the hollow shaft 702. The end arm 710 may optionally be attached to the hollow shaft 702 so as to create an airtight and watertight seal, for example by adhesive, chemical welding, thermal welding, or similar means for sealing. Another arm 712 having a through-hole sized for a sliding fit of the hollow shaft 702 is placed at a selected location along the hollow shaft and optionally fixed in place with adhesive, by welding, or with one or more threaded fasteners or rivets. A handle 708 surrounds an end segment of the hollow shaft 708 to provide a comfortable and secure hand grip.

As shown in FIG. 9, a first rotatable disk 714 is attached to the end arm 710. The means of attachment between the rotatable disk and the end arm 710 may be by any method which retains the rotatable disk 714 against the end arm 710 while allowing the rotatable disk to revolve as the grooming tool 100 is stroked across an animal's fur. A second rotatable disk 714 is similarly attached to the other arm 712. At least three pieces of surgical tubing 716 are attached to nipples in the rotatable caps, as previously explained in relationship to FIG. 3. In a preferred embodiment, four pieces of surgical tubing are attached to the two rotatable disks 714. In the view shown in FIG. 9, two of four pieces of surgical tubing 716 are visible.

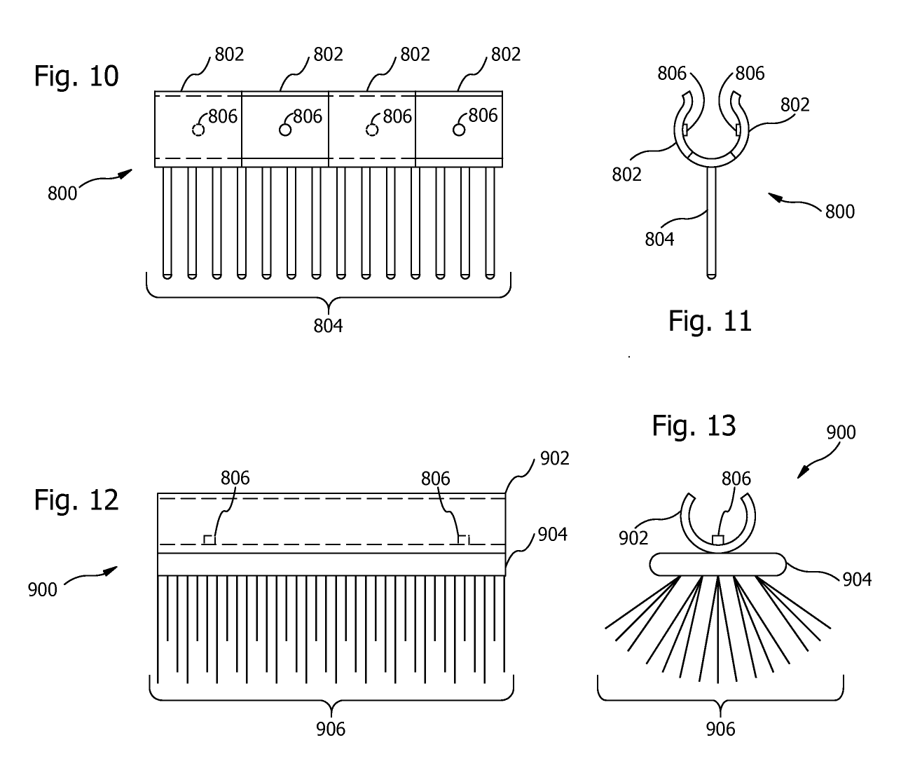

Some embodiments of a grooming tool include detachable grooming accessories. FIG. 10 shows a side view of an example of a detachable comb 800 for use with an embodiment of the invention. FIG. 11 shows an end view of the detachable comb 800 of FIG. 10. As shown in FIG. 10 and FIG. 11, a detachable comb includes a plurality of comb teeth 804 attached to one or more clips 802. The clips 802 include flexible segments having a size and shape selected for removable attachment to the shaft of a grooming tool. A detachable comb 800 may optionally include one or more locating posts 806. A locating post 806 has a size and shape selected to fit into a corresponding depression, aperture, or groove in the shaft of a grooming tool. For example, a locating post 806 optionally has a size and shape selected for a sliding fit into a threaded aperture 704 in a hollow shaft 702. Other holes may optionally be provided in the hollow shaft 702 for the purpose of receiving locating posts 806. A locating post 806 aids in correctly positioning a detachable accessory on a hollow shaft of a grooming tool and also prevents the detachable accessory from rotating about the hollow shaft as the grooming tool is pulled though an animal's fur.

FIG. 12 shows another example of a detachable grooming accessory, a detachable brush. In the side view of a detachable brush 900 in FIG. 12 and the corresponding end view of FIG. 13, a plurality of brush bristles 906 are attached to a brush base 904. A clip 902 is also attached to the brush base 904. Alternatively, the brush base 904 and clip 902 are made as an integral piece. One or more locating posts 806 are optionally attached to the inside of the clip 902.

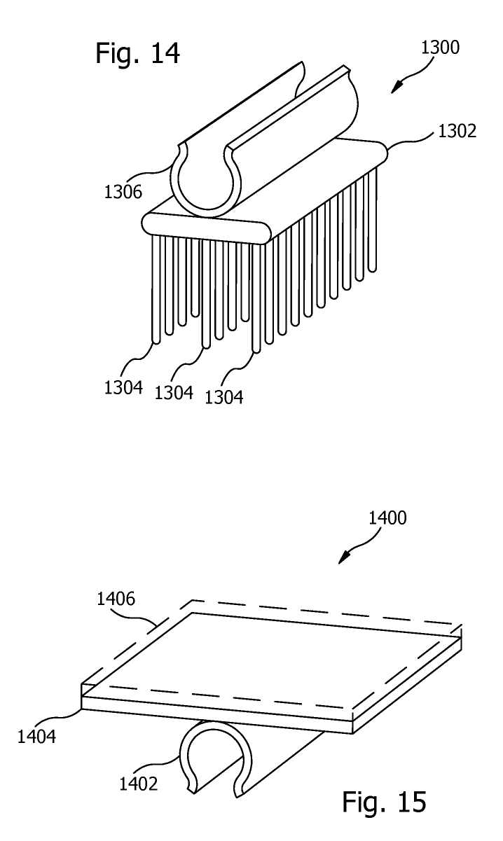

A detachable comb may optionally include more than one row of comb teeth. FIG. 14 shows an example of a detachable comb 1300 having a plurality of comb teeth 1304 arranged in three rows on a base 1302. One or more clips 1306 for attachment of the comb 1300 to the shaft of a grooming tool are also attached to the base 1302. Alternately, the base and clip may be made as an integral piece. Alternative embodiments of a detachable comb may be made with different spacing between comb teeth, different lengths of comb teeth, different numbers of comb teeth, and different numbers of rows of comb teeth than are shown in FIG. 14.

FIG. 15 shows a pictorial view of another example of a detachable grooming accessory which may included with an embodiment of the invention. In the example of FIG. 15, a detachable heating pad accessory 1400 includes a heating pad base 1404 attached to a clip 1402. Alternately, the heating pad base 1404 and clip 1402 may be made as an integral part. The heating pad base 1404 provides a convenient attachment surface for a chemical heating pad, represented in FIG. 15 by a dashed heating pad outline 1406. A chemical heating pad is a commercially available product which generates heat when chemicals stored in a flexible watertight envelope are mixed together, for example by squeezing the envelope, or when a trigger mechanism in the envelope is activated, for example by bending a metal disk inside the envelope. A chemical heating pad suitable for use with an embodiment of the invention has a low-strength adhesive on one side of the pad so that the pad may be removably affixed to the heating pad base 1404 of the detachable heating pad accessory 1400. In other embodiments, a heating pad may be electrically powered, for example a battery-powered low voltage heating pad encased in a watertight silicone rubber envelope.

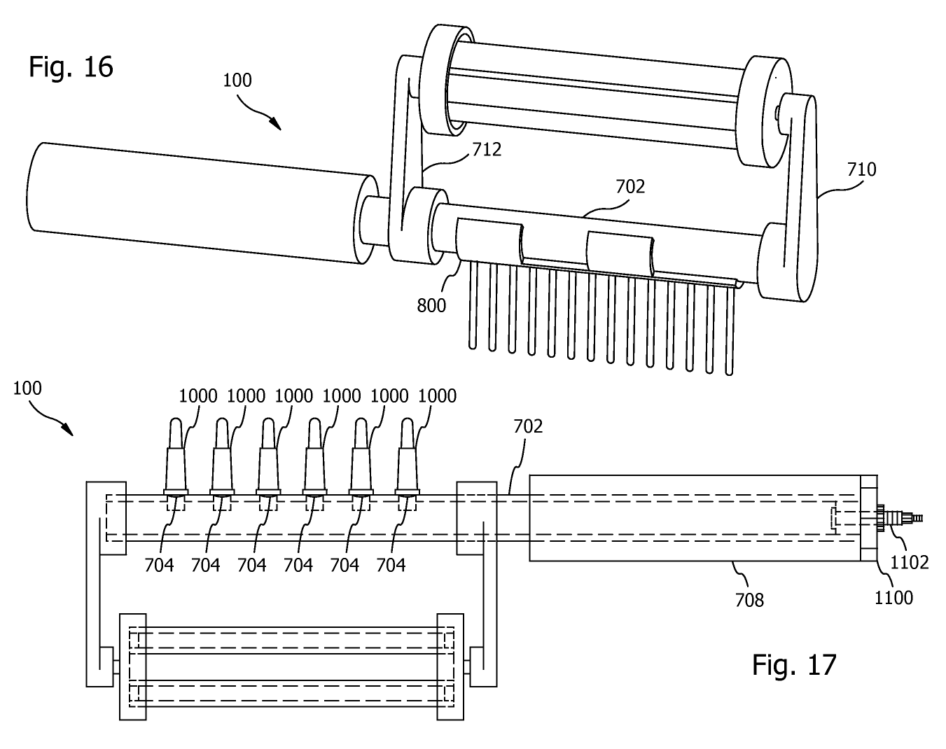

FIG. 16 shows an example of a detachable grooming accessory attached to an embodiment of a grooming tool 100. As shown in FIG. 16, a detachable comb 800 is clipped onto the hollow shaft 702 between the arm 712 and the end arm 710. Any of the detachable grooming accessories disclosed herein may be clipped onto to the hollow shaft 702 of the grooming tool 100 as shown for the example of the detachable comb 800.

The embodiment of a grooming tool 100 shown in FIG. 9 and FIG. 16 may optionally be configured to dispense a fluid such as a liquid, gel, or paste onto an animal's fur or skin. Some examples of fluid which may be dispensed from an embodiment of the invention include, but are not limited to, medications for treatment of fleas or parasites, medications for treatment of skin diseases, and preparations for cleaning, applying scents or fragrances, or hair conditioning. Various dry powders ground finely enough to have fluid-like flow properties may also be dispensed from an embodiment of the invention, and such powders are therefore considered to be within the scope of references to a fluid herein.

An example of an embodiment of a grooming tool for dispensing fluid onto an animal's fur is shown in the side view of FIG. 17. In the example of FIG. 17, the grooming tool 100 is shown with a plurality of fluid dispensing comb teeth 1000 removably connected to the threaded apertures 704 in the hollow shaft 702. A pressure cap 1100 is threaded into the end of the hollow shaft 702 nearest the handle 708. The pressure cap 100 may be removed to fill the hollow shaft 702 with a fluid to be dispensed from the grooming tool 100. After the pressure cap 1100 is threaded tightly into the hollow shaft 702, the hollow interior of the hollow shaft, the end arm 710, and the pressure cap 1100 form an enclosed volume for containing pressurized fluid to be dispensed from the grooming tool 100.

An air valve 1102 in the pressure cap 1100 enables the enclosed volume in the hollow shaft 702 to be pressurized with air from a bicycle tire pump, automobile tire pump, or other sources of pressurized air. In the example of FIG. 17, the air valve is a Presta valve. Other types of air valves may optionally be used in place of a Presta valve, for example a Schrader valve or an industrial quick-disconnect fitting as used on some air tools. Air pressure inside the enclosed volume of the hollow shaft 702 causes fluid inside the hollow shaft 702 to be released through the fluid dispensing comb teeth 1000 when the teeth are pressed firmly against a solid surface such as an animal's skin. An amount of fluid released through the fluid dispensing comb teeth 1000 may optionally be controlled by pressurizing the enclosed volume in which the fluid is stored to a selected magnitude of air pressure.

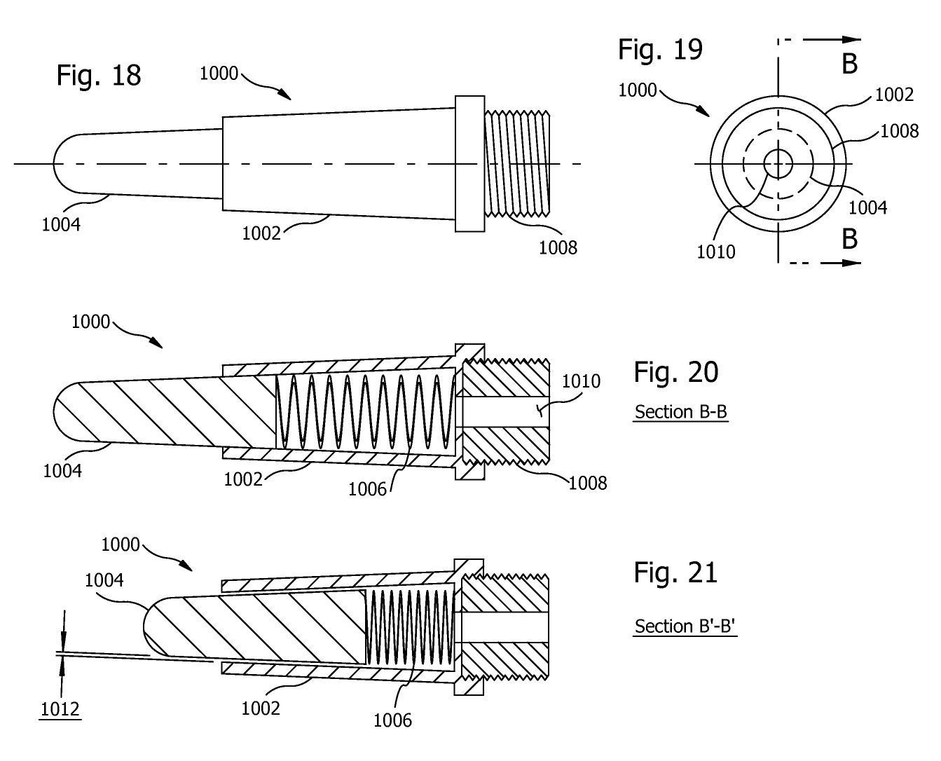

A fluid dispensing comb tooth suitable for use with an embodiment of the invention functions as a valve in which a fluid pathway is opened by applying a force to an end of the comb tooth, thereby depressing a movable element in the comb tooth, and closed by removing force on the end of the comb tooth. A force may be applied to an end of a comb tooth by, for example, pressing the comb tooth against an animal's skin or fur. An example of a fluid dispensing comb tooth is shown from the side in FIG. 18. In the example of FIG. 18, a fluid dispensing comb tooth 1000 includes a valve body 1002, a threaded coupling 1008 having threads compatible with the threaded holes 704 in the hollow shaft 702, and a slidable tip 1004. FIG. 19 shows an end view of the example of FIG. 18. FIGS. 20 and 21 show cross-sectional views of the fluid dispensing comb tooth of FIGS. 18 and 19. A location and viewing direction for the cross sections in FIGS. 20 and 21 are marked by a line labeled B-B in FIG. 19.

As may be seen in FIGS. 18-21, the slidable tip 1004 has a tapered exterior surface. The taper of the slidable tip 1004 matches a corresponding taper on an inside surface of the valve body 1002. When the slidable tip 1004 is in a closed position, the tapered outside surface of the slidable tip 1004 seals against the tapered inside surface of the valve body 1002, as indicated in Section B-B in FIG. 20. The slidable tip 1004 is held in a closed position by a helically wound compression spring 1006 which acts against an internal surface of the slidable tip 1004 and internal surface of the valve body 2002. Fluid is not released through the fluid dispensing comb tooth 1000 when the slidable tip 1004 is in a closed position, as in FIG. 20.

When the slidable tip 1004 is depressed toward the threaded coupling 1008 by applying a mechanical force against the rounded end of the slidable tip 1004, as shown in Section B′-B′ in FIG. 21, the compression spring 1006 is compressed and a gap 1012 appears between the opposing tapered surfaces of the slidable tip 1004 and valve body 1002. The gap 1012, the volume inside the valve body 1002 in which the compression spring 1006 rests, and a central aperture 1010 in the threaded coupling 1008 form a continuous fluid pathway for dispensing fluid stored in the hollow shaft of the grooming tool. An amount of fluid which passes through the fluid dispensing comb tooth 100 may be controlled by controlling an amount of mechanical force against the slidable tip 1004, for example by controlling how firmly the grooming tool is pressed against an animal's skin. An amount of fluid released from the grooming tool may also be controlled by tipping the tool as it is pressed against a surface so that some fluid dispensing comb teeth open up more than others.

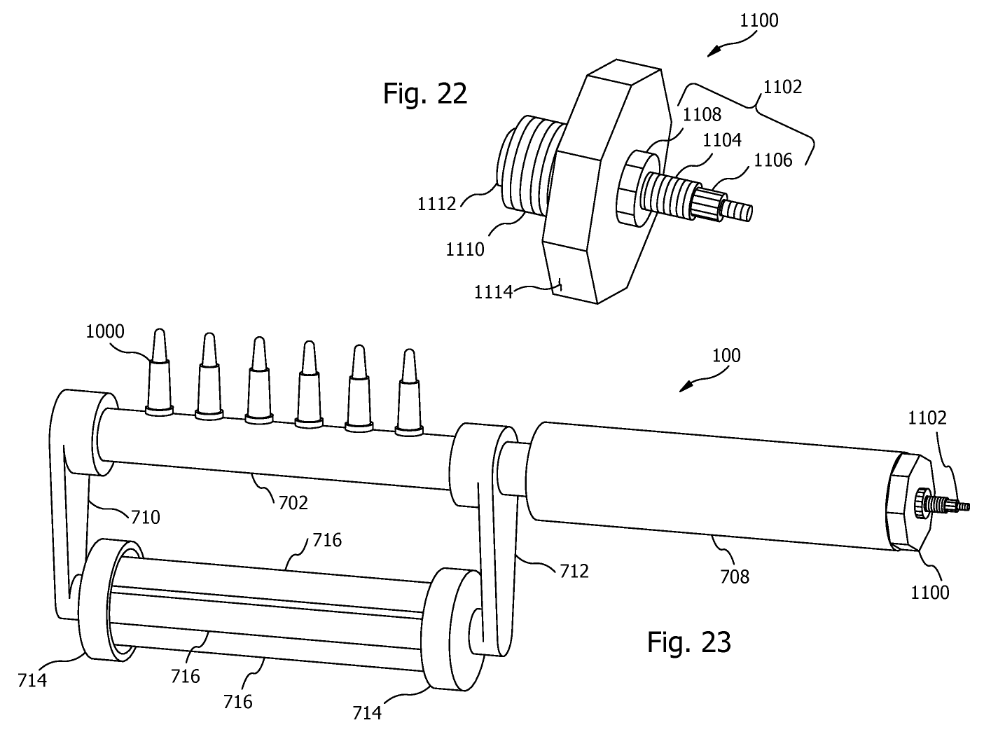

A pressure cap threaded onto an end of the hollow shaft enables the enclosed volume inside the hollow shaft and fluid dispensing comb teeth to be pressurized with air. A pictorial view of an example of a pressure cap 1100 is shown in FIG. 22. The example of a pressure cap 1100 in FIG. 22 includes a cap with an externally threaded plug 1110 and a flattened polygonal cap with a plurality of facets 1114 for providing a finger grip on the cap. Alternatively, the cap may be provided with knurling, ridges, or protrusions selected to facilitate tightening the cap by hand. The pressure cap 1100 also includes an air valve 1102 for pressurizing the chamber in which fluid to be dispensed is stored. In the example of FIG. 22, the air valve 1102 is a Presta valve having a base flange 1112, an externally threaded air valve body 1104 passing through the central aperture in the threaded plug and flattened cap portions of the pressure cap 1100, a retaining nut 1108 for holding the air valve 1102 firmly to the pressure cap 1100, and an air valve lock nut 1106 for opening and closing the Presta valve. The Presta valve of FIG. 22 may optionally be replaced with other styles of air pressure fittings, for example a Schrader valve or an industrial quick-disconnect of the type commonly used with tools driven by compressed air.

An example of a grooming tool adapted for dispensing fluid during grooming is shown in FIG. 23. The pictorial view of FIG. 23 shows an end arm 710 on an end of a hollow shaft 702, a pressure cap 1100 with an air valve 1102 on an opposite end of the hollow shaft 702, another arm 712 located at a selected position along the length of the hollow shaft 702, a handle 708 surrounding part of the hollow shaft 702, and a plurality of fluid dispensing comb teeth 1000 attached to the hollow shaft 702. FIG. 23 further illustrates several pieces of latex surgical tubing 716 attached to a pair of rotatable disks 714, each disk rotatably attached to a separate arm (712, 714). The assembly comprising the two rotatable disks 714 and pieces of latex surgical tubing 716 rotates as a unit when the pieces of tubing 716 are drawn across an animal's fur.

In some embodiments of a grooming tool, the threaded coupling 1008 visible in FIGS. 18-21 is optionally attached to the hollow shaft of the tool, for example by threading, adhesive, or welding. In embodiments in which the threaded coupling remains attached to the hollow shaft, locating posts (see, for example locating posts 806 in FIGS. 10-13) may optionally be replaced by through-holes through a detachable grooming accessory, the through-hole having a size and location selected to provide a clearance fit for a threaded coupling attached to the hollow shaft.

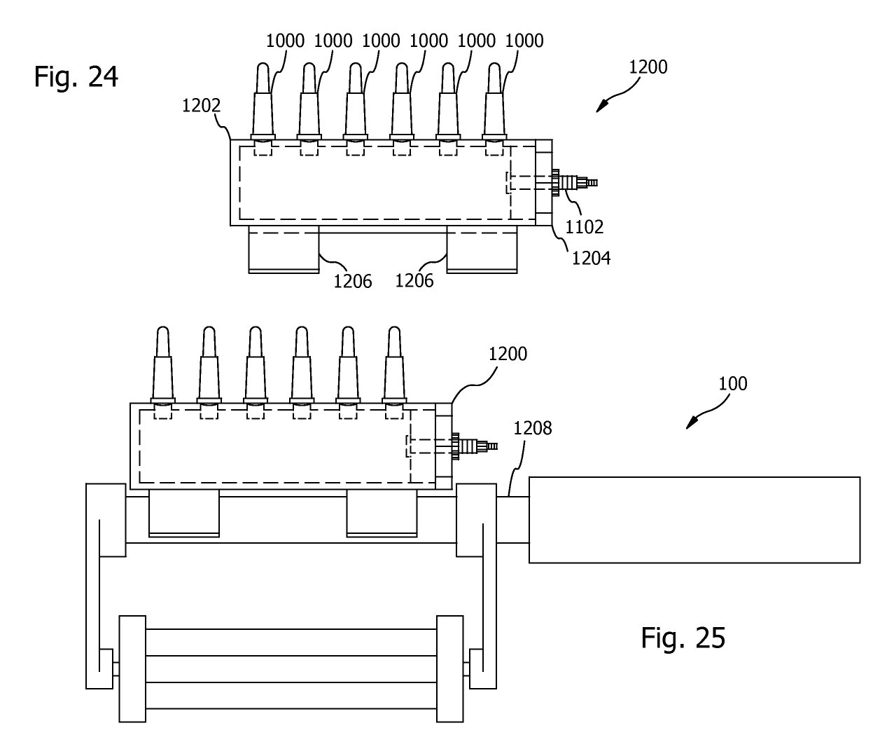

A fluid dispensing comb may optionally be provided as a detachable accessory. FIG. 24 shows a side view of an example of a detachable fluid dispensing comb 1200. In the example of FIG. 24, a fluid container 1202 has a hollow interior volume into which a fluid to be dispensed may be placed after removing a pressure cap 1204. Attaching the removable pressure cap 1204 to the fluid container 1202, for example by engaging threading on the cap with corresponding threading inside the fluid container, closes the fluid container and forms a fluid reservoir which may be pressurized with an air pump through air valve 1102. Fluid stored inside the fluid container 1202 is dispensed through a plurality of fluid dispensing comb teeth 1000. One or more clips 1206 are provided for removable attachment of the fluid dispensing comb 1200 to the shaft of a grooming tool. Clips 1206 on the detachable fluid dispensing comb 1200 are comparable in design and function to clips shown in the examples of detachable grooming accessories from FIGS. 10-15.

FIG. 25 shows a side view diagram of a grooming tool 100 with the detachable fluid dispensing comb 1200 of FIG. 24 snapped onto the shaft 1208 of the grooming tool. The fluid dispensing comb 1200 may alternatively be snapped onto the shaft 1208 with the air valve facing the handle of the grooming tool, as shown in FIG. 25, or rotated end for end so that the air valve faces in the opposite direction. A detachable fluid dispensing comb 1200 may be used with a grooming tool having either a hollow shaft as in the example of FIGS. 7-9, or a solid shaft.

A vibratory motion of a grooming tool is beneficial in some situations. For example, a vibratory motion of a detachable grooming accessory may make it easier to pull the accessory through matted or tangled fur or hair. Or, gentle vibration may help calm or soothe an animal being groomed. Gentle vibration may also have therapeutic uses, for example to relieve muscle stress. Some embodiments of the invention therefore include a means for vibrating parts of a grooming tool that may come into contact with an animal's skin or fur. A means for vibrating suitable for use with an embodiment of a grooming tool includes, but is not limited too, an electrically powered motor having a rotating weight eccentrically connected to the motor's drive shaft or an electrical solenoid with a core which may be rapidly extended and retracted. Such electrically powered vibratory devices, referred to herein as vibration motors, may be coupled to a detachable grooming accessory fitted with flexible contact fingers, comb teeth, brush bristles, and the like. In a preferred embodiment, a vibration motor operates from a low voltage direct current (DC) power source such as a battery pack comprising one or more batteries. In other embodiments, a vibration motor is powered from an external power source electrically connected to the detachable accessory or to the grooming tool.

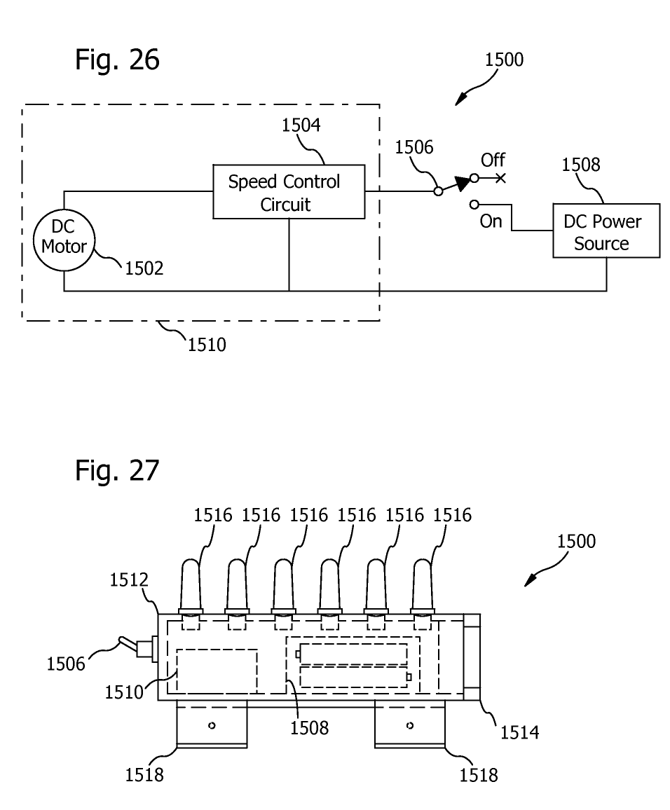

FIG. 26 shows a schematic diagram of detachable vibrator accessory 1500 which may optionally be included with an embodiment of the invention. In the example of FIG. 26, a DC power source is electrically connected to a switch 1506, to an optional speed control circuit 1504, and to a DC motor 1502. The DC motor 1502 and speed control circuit 1504 may optionally be combined into an integrated vibration motor 1510. In some embodiments, a vibration motor 1510 operates without a speed control circuit 1504. Closing the switch 1506 connects electrical voltage and current from the DC power source 1508 to the DC motor 1502 and optional speed control circuit 1504, causing an output shaft of the DC motor 1502 to rotate. Shaft rotation causes a corresponding vibration from rotation of a weight eccentrically attached to the shaft. A DC power source 1508 may include, but is not limited to, one or more batteries or an alternating current to DC current converter.

In some embodiments of a grooming tool, the vibration motor 1510 and other components shown in FIG. 26 are installed inside the hollow shaft of a grooming tool. In other embodiments of a grooming tool, the vibration motor and DC power source are installed inside a detachable enclosure adapted for connection to the shaft of the grooming tool, as shown in the example of FIG. 27. In FIG. 27, a detachable vibrator accessory 1500 includes an enclosure 1202 having an interior volume in which a vibration motor 1510 and a DC power source 1508 are installed. In the example of FIG. 27, the DC power source 1508 comprises two batteries in a battery carrier. In other embodiments, a different number and arrangement of batteries are used to power the vibration motor 1510. A removable cap 1514 attaches to the enclosure 1512 for closing the space holding the vibration motor and batteries. A switch 1506 on an outside surface of the enclosure 1512 enables the vibration motor 1510 to be turned on and off. One or more clips 1518 enable the detachable vibrator accessory 1500 to be clipped onto a grooming tool.

The vibration motor 1510 is firmly attached to an inside surface of the enclosure 1512 so that vibrations from the vibration motor are coupled efficiently to other parts of the detachable vibrator accessory 1500. During grooming, vibrations are coupled into the skin or fur of an animal though a plurality of contact fingers 1516 attached to the enclosure 1512. Contact fingers 1516 may optionally be removable for replacement, to exchange one shape of contact finger for another, or to stack another detachable grooming accessory on top of the detachable vibrator accessory 1500. In alternative embodiments of the invention, contact fingers 1516 are provided in different numbers, sizes, and shapes than are shown in FIG. 27. Contact fingers may optionally be provided in materials with different degrees of mechanical stiffness.

A detachable vibrator accessory may optionally be made with an outside diameter that is approximately the same as an outside diameter of a shaft of a pet grooming tool, for example the shaft 1208 in the embodiment of a pet grooming tool 100 illustrated in FIG. 25, in order that other detachable grooming accessories may be attached to the vibrator accessory. Alternatively, a vibrator accessory may be made with any convenient outside diameter, and clips on detachable grooming accessories made to accommodate a range of diameters including the shaft of the pet grooming tool and the outside diameter of the vibrator. Contact fingers on the vibrator (see for example contact fingers 1516 in FIG. 27) may optionally be removed before another grooming accessory is attached to the vibrator, or other accessories may be made with apertures allowing the contact fingers to remain in place, the contact fingers passing through the apertures in an accessory attached to the vibrator.

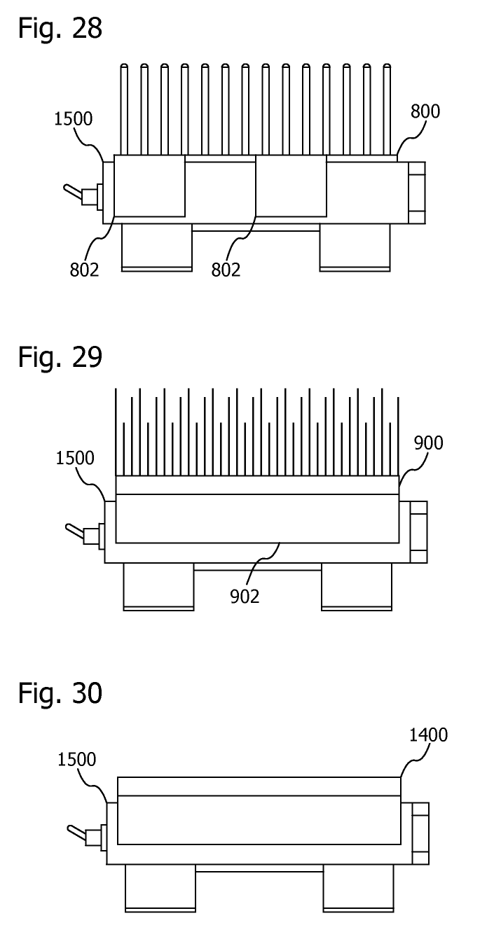

Some examples of combinations of detachable grooming accessories and a detachable vibrator accessory are shown in FIGS. 28-30. In FIG. 28, a detachable comb 800 is clipped onto a vibrator 1500. Clips 802 on the detachable comb 800 grip an outside surface of the vibrator 1500. In FIG. 29, a detachable brush 900 is attached to a vibrator 1500. FIG. 30 shows an example of a heating pad accessory 1400 attached to a vibrator 1500.

An example of a method in accord with an embodiment of the invention includes the following steps:

introducing a fluid to be dispensed from a grooming tool into a hollow shaft in the grooming tool;

sealing the end of the hollow shaft with a pressure cap;

pressurizing the hollow shaft with air introduced through an air valve in the pressure cap;

pressing the ends of fluid dispensing comb teeth on the grooming tool against the animal's skin while pulling the fluid dispensing comb teeth through the animal's fur; and

releasing fluid through the fluid dispensing comb teeth and onto the animal's skin and fur.

The method described above may optionally include any of the following steps, singly or in combination:

controlling an amount of fluid dispensed from the grooming tool by controlling an amount of force by which the grooming tool is pressed against the animal's skin;

controlling an amount of fluid dispensed from the grooming tool by selectively pressing fewer than all of fluid dispensing comb teeth against the animal's skin;

controlling an amount of fluid dispensed from the grooming tool by selectively pressing some fluid dispensing comb teeth against an animal's skin more firmly than other fluid dispensing comb teeth; and

controlling an amount of fluid dispensed from the grooming tool by pressurizing an interior volume of the grooming tool with a selected magnitude of air pressure.

While the present invention has been described with reference to several particular example embodiments, those skilled in the art will recognize that many changes may be made thereto without departing from the spirit and scope of the present invention, which is set forth in the following claims.

1. An animal grooming tool, comprising:
a plurality of latex surgical tubing pieces generally arranged parallel to one another, and anchored as a group at corresponding opposite ends;
a handle providing for a user to draw said plurality of latex surgical tubing pieces across the animal for grooming;
a shaft having an outer surface, wherein said shaft is attached to said handle;
a toothed comb comprising a plurality of comb teeth attached to said shaft, wherein said comb teeth extend in a first direction approximately perpendicular to said outer surface of said shaft; and
a first arm and a second arm, wherein said first arm and said second arm extend from said surface of said shaft in a second direction opposite to said first direction and said plurality of latex surgical tubing pieces are rotatably coupled to said first and second arms,
wherein said shaft is hollow, said shaft is formed with a plurality of internally threaded apertures for attachment of a plurality of fluid dispensing comb teeth, and said shaft is internally threaded at a first end of the shaft for attachment of a pressure cap.

2. The animal grooming tool of claim 1, further comprising a detachable grooming accessory comprising a clip adapted for removable attachment of said detachable grooming accessory to said shaft.

3. The animal grooming tool of claim 2, wherein said detachable grooming accessory further comprises a plurality of comb teeth.

4. The animal grooming tool of claim 2, wherein said detachable grooming accessory further comprises a plurality of brush bristles attached to a brush base.

5. The animal grooming tool of claim 2, wherein said detachable grooming accessory comprises a detachable fluid dispensing comb.

6. The animal grooming tool of claim 5, wherein said detachable fluid dispensing comb comprises:
a fluid container having an internal volume for storage of a fluid to be dispensed and clips adapted for removable attachment of said fluid container to the animal grooming tool;
a removable pressure cap adapted for forming a liquid seal against said fluid container and having an air valve for pressuring said interior volume of said fluid container; and
a plurality of fluid dispensing comb teeth adapted for controllably releasing a fluid stored in said interior volume of said fluid container.

7. The animal grooming tool of claim 2, wherein said detachable grooming accessory comprises a detachable heating pad accessory.

8. The animal grooming tool of claim 2, wherein said detachable grooming accessory comprises a detachable vibrator accessory.

9. The animal grooming tool of claim 8, wherein said detachable vibrator accessory comprises an enclosure having clips adapted for removable attachment to the animal grooming tool, a vibration motor attached to an interior surface of said enclosure, a plurality of contact fingers attached to an exterior surface of said enclosure, and a dc power source electrically connected to said vibration motor.

10. The animal grooming tool of claim 9, wherein another of said detachable grooming accessory is removably attached to said detachable vibrator accessory, and said detachable vibrator accessory is removably attached to said animal grooming tool.

11. The animal grooming tool of claim 1, further comprising a pressure cap removably attached to said first end of said shaft.

12. The animal grooming tool of claim 11, where said pressure cap further comprises an air valve.

13. The animal grooming tool of claim 12, further comprising a plurality of fluid dispensing comb teeth removably attached to said shaft at said plurality of internally threaded apertures.

14. The animal grooming tool of claim 13, wherein each of said plurality of fluid dispensing comb teeth comprise a valve body having a conical inner surface, a slidable tip having a conical outer surface, and a compression spring pressing against an end of said slidable tip and against an inner surface of said valve body.

15. A method for grooming an animal, comprising:
introducing a fluid to be dispensed from a grooming tool into a hollow shaft in the grooming tool;
sealing the end of the hollow shaft with a pressure cap;
pressurizing the hollow shaft with air introduced through an air valve in the pressure cap;
pressing the ends of fluid dispensing comb teeth on the grooming tool against the animal's skin while pulling the fluid dispensing comb teeth through the animal's fur; and
releasing fluid through the fluid dispensing comb teeth and onto the animal's skin and fur.

16. The method for grooming an animal of claim 15, further comprising controlling an amount of fluid dispensed from the grooming tool by controlling an amount of force by which the grooming tool is pressed against the animal's skin.

17. The method for grooming an animal of claim 15, further comprising controlling an amount of fluid dispensed from the grooming tool by selectively pressing fewer than all of fluid dispensing comb teeth against the animal's skin.

18. The method for grooming an animal of claim 15, further comprising controlling an amount of fluid dispensed from the grooming tool by selectively pressing some fluid dispensing comb teeth against an animal's skin more firmly than other fluid dispensing comb teeth.

19. The method for grooming an animal of claim 15, further comprising controlling an amount of fluid dispensed from the grooming tool by pressurizing an interior volume of the grooming tool with a selected magnitude of air pressure.
